(19) United States
(12) Patent Application Publication
(10) Pub. No.: US 2014/0307968 A1
(43) Pub. Date: Oct. 16, 2014

(54) METHOD AND APPARATUS FOR AUTOMATIC GENRE IDENTIFICATION AND CLASSIFICATION

(71) Applicant: Tanushyam Chattopadhyay, Kolkata (IN)

(72) Inventor: Tanushyam Chattopadhyay, Kolkata (IN)

(73) Assignee: TATA CONSULTANCY SERVICES LIMITED, Mumbai (IN)

(21) Appl. No.: 14/363,786

(22) PCT Filed: Dec. 4, 2012
(86) PCT No.: PCT/IN12/00790

§ 371 Date: Jun. 6, 2014

(30) Foreign Application Priority Data
Dec. 7, 2011 (IN) 3429/MUM/2011

(51) Int. Cl. G06K 9/62

(52) U.S. Cl. CPC G06K 9/6267
USPC 382/187

(57) ABSTRACT

An automated method for classifying a video frame into different genre based on the statistical analysis of different text rich video frames. The method of the present invention applies a statistical method to classify the genre based on the text in the video frame.

### FIELD OF THE INVENTION

The present invention generally relates to the field of genre identification and, more particularly, to an automated system and method for genre identification and classification.

### BACKGROUND OF THE INVENTION

The advances in the field of electronic capturing, processing storing, transmitting and reconstructing a sequence of still images have enabled rampant access to variety of videos. The collection of large quantities of videos makes it difficult to obtain the relevant information as there is no structured classification scheme to categorize these videos. The information of genre is usually obtained from Electronic Program Guide. However, in case of cable or radio frequency feed TV channels it is not possible to obtain EPG using any existing technology. Moreover sometimes sports events (like IPL) are telecasted over a channel which is typically designated for transmitting movies (like set max). If the texts of the video frames are obtained, existing technology uses natural language processing to classify the genre of TV videos. But NLP based approaches are highly language model or word net dependent.

Classification of digital video into categories such as sports, news, movies, commercials, documentaries and surveillance is an important task which requires greater efficiency in indexing, filtering, retrieval and browsing of the data from diverse sources or large repositories. In the light of foregoing, there exists a need for an automated genre classification system that can readily identify the context rich digital video and classify them into appropriate genres for quick and improved retrieval purposes.

### OBJECTIVES OF THE INVENTION

The principle object of the present invention is to provide a system capable of identifying and classify the genre of TV video.

Another significant object of the invention is to present a system that enables quick, reliable and effective retrieval of specified TV video based on the user preference without having to dive into from large repositories of videos.

Another object of the invention is to classify the TV video genre into either of sports, music, movies and news genre.

### SUMMARY OF THE INVENTION

Before the present methods, systems, and hardware enablement are described, it is to be understood that this invention is not limited to the particular systems, and methodologies described, as there can be multiple possible embodiments of the present invention which are not expressly illustrated in the present disclosures. It is also to be understood that the terminology used in the description is for the purpose of describing the particular versions or embodiments only, and is not intended to limit the scope of the present invention which will be limited only by the appended claims.

The present invention envisages a method to classify the genre of TV video by recognizing the text in the video frame. The proposed method applies a statistical method to classify the genre based on the texts in the video frame.

In the preferred embodiment of the invention a computer implemented method of classifying a text containing video frame is provided, wherein the said method comprises of the following steps: processing at least one textual segment, computing average number of characters per video frame using optical character recognition techniques and determining one or more tolerance related threshold value; comparing the computed average value against the determined threshold value to derive a score; and classifying the processed video frame into one or more genres according to the said score.

### BRIEF DESCRIPTION OF THE DRAWINGS

The foregoing summary, as well as the following detailed description of preferred embodiments, are better understood when read in conjunction with the appended drawings, wherein like elements are given like reference numerals. For the purpose of illustrating the invention, there is shown in the drawings example constructions of the invention; however, the invention is not limited to the specific methods and system disclosed. In the drawings:

FIG. 1 is a flow chart representing the method of performing the present invention in accordance with one of the preferred embodiments of the present invention.

### DETAILED DESCRIPTION OF THE INVENTION

Some embodiments of this invention, illustrating all its features, will now be discussed in detail.
The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

The disclosed embodiments are merely exemplary of the invention, which may be embodied in various forms. Software programming code, which embodies aspects of the present invention, is typically maintained in permanent storage, such as a computer readable medium. In a client-server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. The invention may be embodied in computer software, the functions necessary to implement the invention may alternatively be embodied in part or in whole using hardware components such as application-specific integrated circuits or other hardware, or some combination of hardware components and software. Input/output or I/O devices (including but not limited to keyboards, displays, pointing devices, etc.) can be coupled to the system either directly or through intervening I/O controllers. Further, a computerized method refers to a method whose steps are performed by a computing system containing a suitable combination of one or more processors, memory means and storage means.

The genre of a TV show can be very efficiently obtained by consulting the Program Guide of the show at the instant of time. But the EPG is not available for all the channels and also in some of the cases (sports) news is telecasted over a sports channel or sports is telecasted (IPL) over a channel (Set Max) which is usually dedicated for a movie. Moreover usually it is observed that text information is mainly obtained from music videos, movies with subtitle, sports and news. The present invention therefore envisages a method of classifying the genre of TV videos automatically based on the statistical analysis of different text rich TV shows.

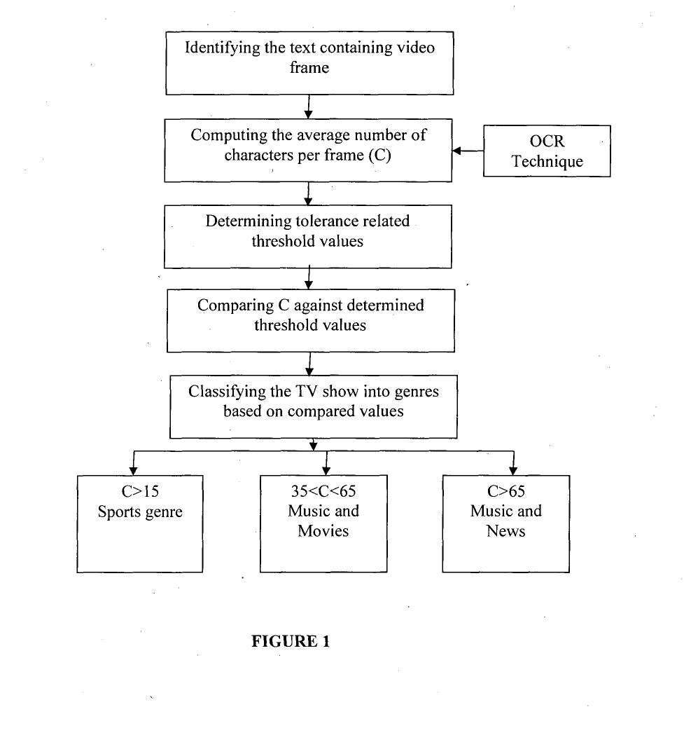

With reference to FIG. 1, the method of performing the present invention firstly involves identifying the text rich regions in a video frame. The methods of obtaining the regions containing text are well known in the art and hence the step can be performed by using any of the known techniques. Optical Character Recognition technique is deployed on the identified textual segments of a rich video frame. If the video frame consists of at least fifteen static (non-scrolling) texts in the video frame, then it belongs either to the following genres:

a) Sports

b) News Text

c) Movies and Music

Next, the average number of characters per frame and the average number of words per frame is calculated using the said OCR technique. A threshold based approach is adopted to differentiate each genre on the statistical analysis on TV video corpus whereby a set of rules are defined such that some tolerance is added to determined threshold values for text classification. These tolerance factors are obtained from the standard deviation of the observed statistics. If the computed average number of characters is greater than 15 and less than 35, the video is classified under sports genre; if the average number of characters is greater than 35 and less than 65, it gets classified under music and movies; and if the number of characters per video frame is greater than 65, then it is music and news.

The foregoing description of specific embodiments of the present invention has been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. The listing of steps within method claims do not imply any particular order to performing the steps, unless explicitly stated in the claim.

1. A computer implemented method for classifying a video frame, comprising:
processing at least one text-rich portion of a video frame using optical character recognition techniques;
computing by one or more processors, an average number of characters per video frame using the processed at least one text-rich portion;
determining one or more tolerance related threshold values for classifying the video frame;
comparing the computed average against the determined one or more tolerance related threshold values to derive a score; and
classifying, by the one or more processors, the video frame into one or more genres according to the derived score.

2. The method of claim 1, wherein the video frame is classified into a sports, music and movies, or news genre.

3. The method of claim 1, wherein the tolerance related threshold values are determined using a statistical approach including a standard deviation based approach.

4. The method of claim 2, wherein the video frame is classified into the sports genre when the computed average number of characters is greater than a tolerance related threshold value, the tolerance related threshold value being 15.

5. The method of claim 2, wherein the video frame is classified into the music and movies genre when the computed average number of characters is greater than a first tolerance related threshold value and less than a second tolerance related threshold value, the first tolerance related threshold value being 35 and the second tolerance related threshold value being 65.

6. The method of claim 2, wherein the video frame is classified into the sports genre when the computed average number of characters is greater than a tolerance related threshold value, the, tolerance related threshold value being 65.

7. A system for classifying a video frame, comprising:
one or more hardware processors; and
one or more memory units storing machine-readable instructions executable by the one or more processors for:
processing at least one text-rich portion of a video frame using optical character recognition techniques;
computing, by one or more processors, an average number of characters per video frame using the processed at least one text-rich portion;
determining one or more tolerance related threshold values for classifying the video frame;
comparing the computed average against the determined one or more tolerance related threshold values to derive a score; and
classifying, by the one or more processors, the video frame into one or more genres according to the derived score.

8. The system of claim 7, wherein the video frame is classified into a sports, music and movies, or news genre.

9. The system of claim 7, wherein the tolerance related threshold values are determined using a statistical approach including a standard deviation based approach.

10. The system of claim 8, wherein the video frame is classified into the sports genre when the computed average number of characters is greater than a tolerance related threshold value, the tolerance related threshold value being 15.

11. The system of claim 8, wherein the video frame is classified into the music and movies genre when the computed average number of characters is greater than a first tolerance related threshold value and less than a second tolerance related threshold value, the first tolerance related threshold value being 35 and the second tolerance related threshold value being 65.

12. The system of claim 8, wherein the video frame is classified into the sports genre when the computed average number of characters is greater than a tolerance related threshold value, the tolerance related threshold value being 65.

13. A non-transitory computer-readable medium storing machine-readable instructions executable by one or more processors for:
processing at least one text-rich portion of a video frame using optical character recognition techniques;
computing, by one or more processors, an average number of characters per video frame using the processed at least one text-rich portion;
determining one or more tolerance related threshold values for classifying the video frame;
comparing the computed average against the determined one or more tolerance related threshold values to derive a score; and
classifying, by the one or more processors, the video frame into one or more genres according to the derived score.

14. The medium of claim 13, wherein the video frame is classified into a sports, music and movies, or news genre.

15. The medium of claim 13, wherein the tolerance related threshold values are determined using a statistical approach including a standard deviation based approach.

16. The medium of claim 14, wherein the video frame is classified into the sports genre when the computed average number of characters is greater than a tolerance related threshold value, the tolerance related threshold value being 15.

17. The medium of claim 14, wherein the video frame is classified into the music and movies genre when the computed average number of characters is greater than a first tolerance related threshold value and less than a second tolerance related threshold value, the first tolerance related threshold value being 35 and the second tolerance related threshold value being 65.

18. The medium of claim 14, wherein the video frame is classified into the sports genre when the computed average number of characters is greater than a tolerance related threshold value, the tolerance related threshold value being 65.
